(19) United States
(12) Patent Application Publication
(10) Pub. No.: US 2011/0247326 A1
(43) Pub. Date: Oct. 13, 2011

(54) Waste Exhaust Energy Recovery from an Engine

(76) Inventor: Shamim Imani, Fullerton, CA (US)

(21) Appl. No.: 12/968,489

(22) Filed: Dec. 15, 2010

Related U.S. Application Data
(60) Provisional application No. 61/323,644, filed on Apr. 13, 2010.

(51) Int. Cl. F02D 23/00; F02G 3/00; F02B 33/44

(52) U.S. Cl. 60/602; 60/605.1; 60/613

(57) ABSTRACT

An aspect encompasses an engine system wherein a turbocharger is coupled to an internal combustion engine to receive exhaust from the engine and to provide compressed air for combustion to the engine. The turbocharger is driven to generate the compressed air by the exhaust from the engine. An expander/generator is coupled to the turbocharger to receive at least a portion of the compressed air and generate electricity by expanding the compressed air.

### REFERENCE TO RELATED APPLICATIONS

The present application claims the benefit, under 35 U.S.C. §119, of U.S. Provisional Patent Application No. 61/323,644, filed Apr. 13, 2010 and entitled “Waste Exhaust Energy Recovery from an Engine,” the entirety of which is hereby incorporated by reference.

### BACKGROUND

A turbocharger is a device, driven off the combustion exhaust of an internal combustion engine, that boosts the pressure and throughput of combustion air into the engine. The turbocharger has a compressor, typically a centrifugal compressor, for compressing the combustion air. The compressor resides on a common shaft with a turbine, typically a radial or axial turbine, for receiving the combustion exhaust and driving the compressor via the common shaft. FIG. 1 shows a typical turbocharged engine arrangement having a reciprocating internal combustion engine 12 with an exhaust manifold 14 and a turbocharger 16 coupled to receive exhaust from the manifold 14. The exhaust passes through the turbine stage of the turbocharger 16 and out an exhaust conduit 18. A wastegate valve 20 upstream of the turbocharger 16 can be selectively operated (e.g., by an Engine Control Unit) to partially bypass the turbocharger 16, directing some of the exhaust directly into the exhaust conduit 18. The exhaust that passes through the turbine stage of the turbocharger 16 drives the compressor stage to compress ambient air received at the turbocharger 16 and output the compressed air through an intake conduit 22 into the intake of the engine 12. The compressed air and fuel are combusted in the engine 12 to produce kinetic energy, typically in the form of rotating movement of an output shaft.

### SUMMARY

The concepts described herein are directed to generating electricity from waste exhaust energy. In certain instances, an expander/generator recovers exhaust energy that would otherwise be wasted, i.e. exhaust energy bypassed via wastegate valve or exhaust energy used to generate compressed air ultimately vented via the blow-off valve, in the form of excess compressed air and expands the excess compressed air to generate electricity.

An aspect encompasses an engine system wherein a turbocharger is coupled to an internal combustion engine to receive exhaust from the engine and to provide compressed air for combustion to the engine. The turbocharger is driven to generate the compressed air by the exhaust from the engine. An expander/generator is coupled to the turbocharger to receive at least a portion of the compressed air and generate electricity by expanding the compressed air.

An aspect encompasses a method where, with a turbocharger, excess compressed air beyond the operating requirements of an internal combustion engine is generated. This excess compressed air is expanded to generate electricity.

An aspect encompasses a method performed on an internal combustion engine having a turbocharger coupled to the engine to receive exhaust from the engine, be driven to generate compressed air by the exhaust from the engine and to provide compressed air for combustion to the engine. In the method an expander/generator is coupled between the turbocharger and the engine to receive at least a portion of the compressed air and generate electricity by expanding the received compressed air.

The details of one or more implementations are set forth in the accompanying drawings and the description below. Features, objects, and advantages will be apparent from the description and drawings, and from the claims.

### DESCRIPTION OF DRAWINGS

FIG. 1 is a schematic flow diagram of a prior art internal combustion engine system having a turbocharger.

FIG. 2 is a schematic flow diagram of an internal combustion engine system having a turbocharger and being configured for waste exhaust energy recovery in accordance with the concepts described herein.

FIG. 3 is a one quarter side cross-sectional view of an example expander/generator that could be used in an internal combustion engine system configured for waste exhaust energy recovery.

FIG. 4 is a side view of an example expander/generator and electronics package in accordance with the concepts described herein.

Like reference symbols in the various drawings indicate like elements.

### DETAILED DESCRIPTION

FIG. 2 shows an exemplary engine system configured for waste exhaust energy recovery. The system 10 includes a reciprocating internal combustion engine 12 of the type that has one or more pistons that reciprocate in one or more cylinders. In other instances, the engine 12 could be another type of engine. For example, the engine 12 could be a non-piston and/or non-turbine type engine, such as a Wankel rotary engine and/or other type of engine.

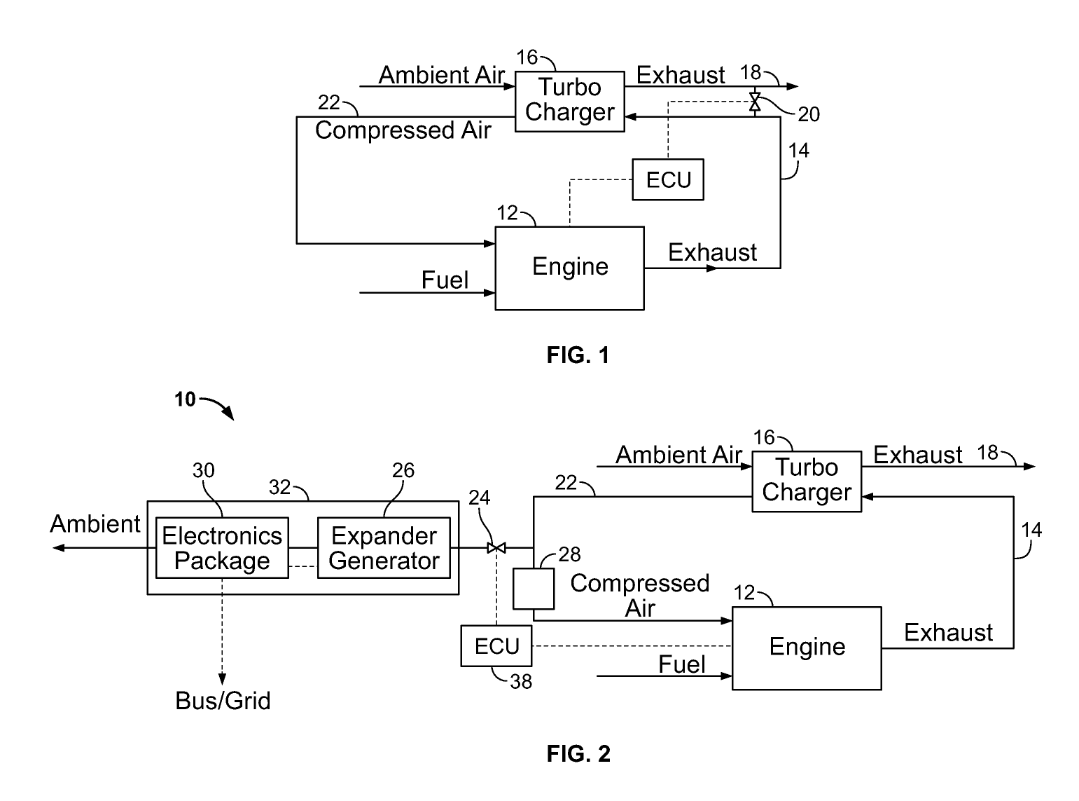

A turbocharger 16 is coupled to receive combustion exhaust from combustion of fuel and air within the internal combustion engine 12 via the engine's exhaust manifold 14. The exhaust passes through the turbine stage of the turbocharger 16 and out an exhaust conduit 18. The exhaust that passes through the turbine stage of the turbocharger 16 drives the compressor stage to compress ambient air received at the turbocharger 16 and output the compressed air through an intake conduit 22 into the intake of the engine 12. The compressed air and fuel are combusted in the engine 12 to produce kinetic energy, typically in the form of rotating movement of an output shaft. Although FIG. 2 shows a configuration without a wastegate valve, in certain instances, a wastegate valve can be provided, as in FIG. 1, upstream of the turbocharger 16 and selectively operated (e.g., by an Engine Control Unit) to partially bypass the turbocharger 16 and direct some of the exhaust directly into the exhaust conduit 18.

The engine system includes an expander/generator 26 coupled to the intake conduit 22 to receive compressed air and direct the compressed air through the expander/generator 26 away from the engine 12. In certain instances, the expander/generator 26 is a turbine (radial and/or otherwise) coupled to an electric generator having a rotor and a stator. The turbine is coupled either directly on a common shaft with the rotor (such that the turbine and rotor rotate at the same speed) or through a gear train (to increase or decrease the ratio of turbine rotations to rotor rotations). Compressed air from the intake conduit 22 is expanded through the turbine of the expander/generator 26, thus causing the turbine to rotate the rotor and operate the generator to produce electricity. The air exiting the expander/generator 26 is vented to the atmosphere and/or, as described below, used for another purpose. A blow-off valve 24 can be included between the intake conduit 22 and expander 26 to selectably control, or restrict, the amount of air provided to the expander/generator 26 and/or bypass the expander/generator 26 completely.

An intercooler 28 (air to air and/or air to liquid) can be provided in the intake conduit 22 to cool the compressed air prior to entry into the engine 12. The expander/generator 26 can receive compressed air from either upstream or downstream of the intercooler 28. However, when upstream as shown in FIG. 2, the air provided to the expander/generator 26 will be hotter than were the air provided to the expander/generator 26 from downstream of the intercooler 28. In certain instances, the hotter air is less prone to condensation. In one example system, the compressed air before the intercooler is about 200° C., and after the intercooler is about 50° C. The air at 200° C. after expansion is expected to be 80-50° C. and less prone to condensation than if air at 50° C. were expanded to a much lower temperature.

Typically, the turbocharger 16 will produce more compressed air than the engine requires during certain operating conditions. For example, in certain instances, when the turbocharger 16 is sized to obtain the necessary pressure and flow at low operating speeds and/or loads on the engine, it produces excess pressure and flow at higher operating speeds and/or loads. In a system without the expander/generator 26, this excess compressed air would be reduced or eliminated by-passing a portion of the engine's exhaust from the turbocharger via a wastegate valve (i.e., to reduce the amount of compressed air generated by the turbocharger) or venting the generated compressed air from the intake conduit 22 via a blow-off or recirculation valve. However, in the present system, all or substantially all of the excess compressed air is provided to the expander/generator 26 and utilized to generate electricity. The turbocharger can thus be operated at full capacity (i.e., without venting exhaust with a wastegate valve) over the engine's 12 operating range, because any excess compressed air beyond the engine's requirements can be directed to the expander/generator 26. In harnessing the excess compressed air, the expander/generator 26 recovers exhaust energy that would otherwise be wasted, i.e. exhaust energy bypassed via wastegate valve or exhaust energy used to generate compressed air ultimately vented via the blow-off or recirculation valve. In certain instances, the turbocharger 16 can be configured to produce more compressed air than the engine requires during additional and/or all operating conditions of the engine, including steady state or near steady state operations in a desired operating range, to produce more electricity than if the turbocharger 26 were conventionally sized. In instances where the engine 12 is driving a relatively constant speed load (e.g., driving a generator, pump, ship's propulsion and/or other load), the amount of excess air available can be readily controlled to be relatively constant and drive the expander/generator 26 to produce a relatively constant amount of power.

In certain instances, the blow-off valve 24 is a pressure actuated valve configured to vent compressed air in the intake conduit 22 in response to a pressure in the intake conduit 22 exceeding a specified pressure (e.g., a pressure over atmospheric, a pressure over the pressure downstream of the engine's throttle and/or another pressure). In certain instances, the blow-off valve 24 is controlled to supply an amount of compressed air to the expander/generator 26 based on the compressed air requirements of the engine 12. For example, an Engine Control Unit (ECU) 38 that is coupled to the engine 12 to control aspects of the engine 12, such as the amount of fuel supplied to the engine, ignition timing, and/or other aspects, can also be coupled to the blow-off valve 24 to adjust the blow-off valve 24 to vary the amount of compressed air supplied to the expander/generator 26 based on the compressed air requirements of the engine 12. In certain instances, the ECU can be configured to ensure that the engine's 12 compressed air requirements are met and any excess compressed air is supplied to the expander/generator 26.

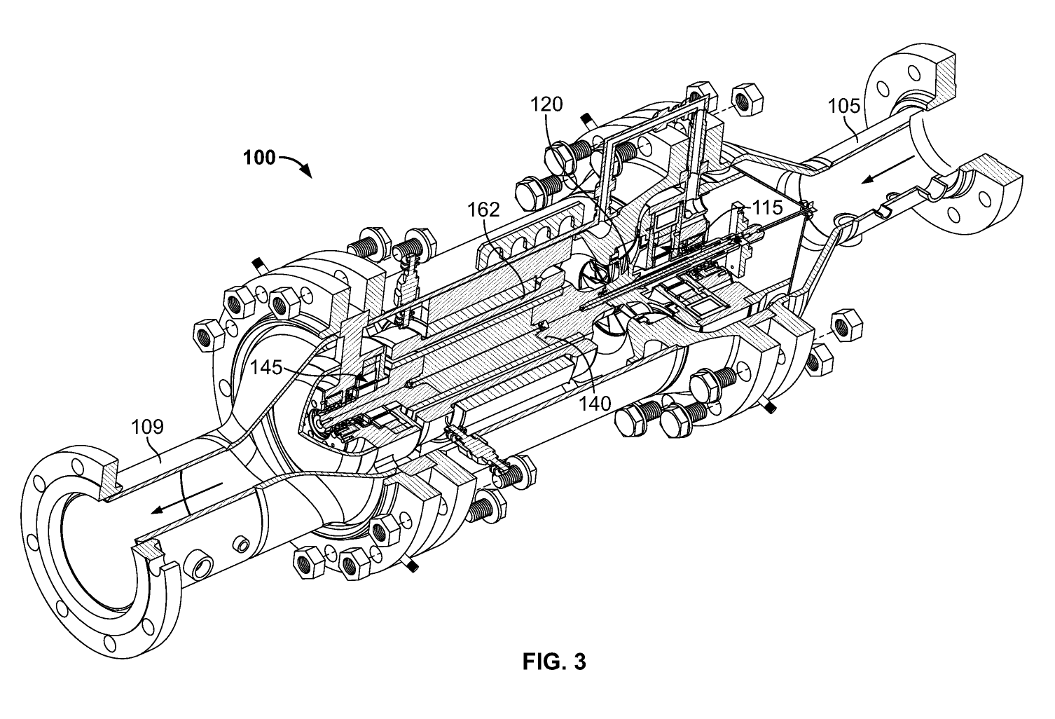

FIG. 3 shows an example expander/generator 100 that can be used as expander generator 26. Excess compressed air from the turbocharger enters the expander/generator 100 through an inlet conduit 105, for example, coupled to intake conduit 22 and/or blow-off valve 24, and thereafter expands through the turbine stage (including turbine wheel 120). The expanded air is then directed, through the generator stage (including stator 162 and rotor 140) to an outlet conduit 109. In certain instances, the expanded air can cool the stator 162 and rotor 140 by passing through the air gap between the stator 162 and rotor 140 and/or by passing through passages around the exterior of the stator 162. In certain instances, the expanded air can be the primary or only cooling system for the stator 162 and rotor 140.

The expander/generator 100 can include bearings 115 and 145 arranged to rotationally support the turbine wheel 120 and rotor 140. In certain instances, one or more of the bearings 115 or 145 can include ball bearings, needle bearings, active and/or passive magnetic bearings, journal bearings, and/or other type of bearings. For example, the first and second bearings 115 and 145 can be magnetic bearings similar to those described in U.S. Pat. No. 6,727,617 assigned to Calnetix Inc.

In certain instances, the rotor 140 can be a permanent magnet rotor, having rare earth and/or other permanent magnets retained by a non-magnetic, non-conductive sleeve. Rotation of the rotor 140 within the stator 162 generates electric power.

Referring back to FIG. 2, the electric power generated by the expander/generator 26 can be transmitted to a generator electronics package 30 arranged outside of the expander/generator 26 to process the electric power before outputting for use. In certain instances, the electronics package 30 can be coupled to a utility power grid or an AC or DC bus for providing electric power to a load or loads for use. The electric power generated by the expander/generator 26 may be of a certain phase, frequency, voltage and be AC or DC, depending on the configuration of the generator and the operating speed of the expander/generator 26. The electronics package 30 reconfigures the phase, frequency, and/or voltage of the electric power to a desired phase, frequency, and/or voltage, for example, to match the power carried on the grid or bus or other specified characteristics. In certain instances the electronics package includes an inverter and/or rectifier for converting power output from the expander/generator 26 from AC to DC or DC to AC depending on the configuration of the expander/generator 26 and the desired output. In certain instances, the electronics package 30 can also include electronics for controlling active magnetic bearings of the expander/generator 26.

In certain instances, the generator electronics package 30 may be used to output 3-phase 60 Hz AC power output at a voltage of about 400 VAC to about 480 VAC, preferably about 460 VAC. In certain instances, the generator electronics package may be used to output a DC voltage of about 12 V to about 270 V, including selected outputs of 12 V, 125 V, 250 V, and 270 V. Other settings, including other phases, frequencies, and voltages, AC or DC are within the concepts described herein. The expander/generator apparatus 100 can be used to generate power in a “stand alone” system in which the electrical power is generated for use in an isolated network (e.g., to power an isolated machine or facility) or in a “grid tie” system in which the power output is linked or synchronized with a power grid network (e.g., to transfer the generated electrical power to the power grid). An example expander/generator similar to expander/generator 100 is described in more detail in U.S. Pat. No. 7,638,892.

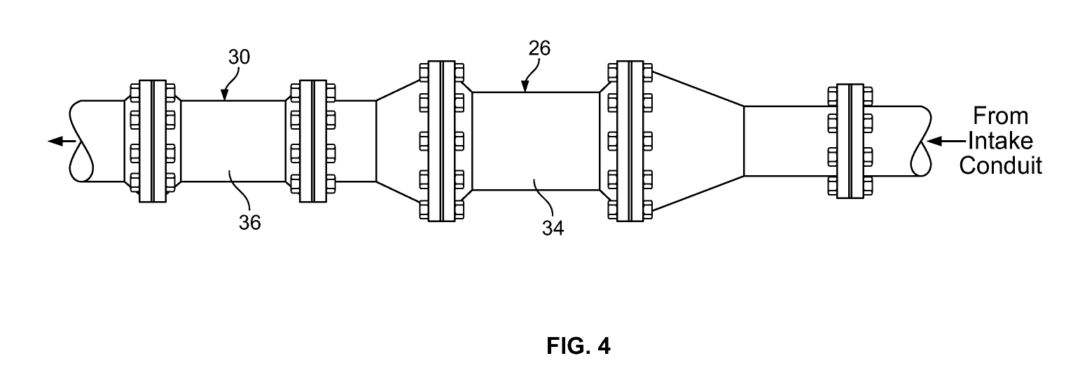

The air exhausted from the expander/generator 26 can be used in cooling the generator electronics package 30. FIG. 2 shows the expander/generator 26 and the electronics package 30 arranged in a common housing 32 with air exhausted from the expander/generator 26 supplied into the generator electronics package 30. FIG. 4 shows the expander/generator 26 and the electronics package 30 arranged in sequential housings (expander/generator housing 34, electronics package housing 36). In FIG. 4 the housings 34, 36 are provided with flanges at their ends to facilitate coupling the expander/generator 26 and electronics package 30 in-line in a piping; however, in other instances the housings 34, 36 can be differently configured.

The waste exhaust energy recovery concepts described herein can be readily retrofitted to an existing internal combustion engine 12 installation. In certain instances, since the expander/generator 26 can be configured as a separate stand-alone device, as contrasted to systems integrated with the turbocharger, it is not necessary to replace and/or reconfigure the turbocharger and/or existing wastegate valve system to incorporate the expander/generator 26 and its electronics package 30 into an existing engine system. Furthermore, as a stand-alone device, no additional ancillary systems are needed. Therefore, retrofitting the expander/generator 26 and its electronics package 30 into an existing engine system can be done by simply coupling the expander/generator 26 to the intake conduit 22, between the turbocharger 16 and the engine 12. A blow-off valve 24 can be provided between the expander/generator 26 and the intake conduit 22 to regulate flow to the expander/generator 26. If configured in the same housing, the expander/generator 26 and electronics package 30 can be pre-coupled so that the outlet of the expander/generator 26 is directed to cool the electronics package 30. Alternately, the electronics package 30 can be coupled to the outlet of the expander/generator 26 as in FIG. 4.

The concepts described herein can be applied to multiple different engine applications. For example, the expander/generator can be installed on ship board engines, including those used for ship propulsion. The expander/generator can be installed on stationary engines, such as those used to run compressors, pumps, and other equipment. The expander/generator can be installed on road going and off-road vehicle engines, as well as locomotive engines. Still further example applications exist.

A number of implementations have been described. Nevertheless, it will be understood that various modifications may be made. Accordingly, other implementations are within the scope of the following claims.

What is claimed is:

1. A engine system, comprising:
an internal combustion engine;
a turbocharger coupled to the engine to receive exhaust from the engine and to provide compressed air for combustion to the engine, the turbocharger configured to be driven to generate the compressed air by the exhaust from the engine; and
an expander/generator between the turbocharger and the engine to receive at least a portion of the compressed air and generate electricity by expanding the received compressed air.

2. The engine system of claim 1, wherein the expander/generator comprises a turbine coupled to a generator between an inlet of the expander/generator and an outlet of the expander, and compressed air received at the inlet flows through the turbine and generator to the outlet.

3. The engine system of claim 1, further comprising an intake conduit between the turbocharger and the engine to communicate compressed air from the turbocharger into the engine, and wherein the expander/generator is coupled to the intake conduit and directs compressed air received by the expander/generator away from the engine.

4. The engine system of claim 3, further comprising a valve between the expander/generator and the intake conduit, the valve operable to restrict flow from the intake conduit to the expander/generator.

5. The engine system of claim 4, further comprising an Engine Control Unit (ECU) coupled to the engine and the valve and configured to control the valve based on compressed air requirements of the engine.

6. The engine system of claim 1, further comprising an electronics package coupled to the expander/generator to receive electric power generated by the expander/generator and adjust at least one of phase, frequency, or voltage of the electric power, the electronics package further coupled to the expander/generator to receive air exhausted from the expander/generator.

7. The engine system of claim 6, wherein the electronics package further comprises a magnetic bearing controller for controlling an active magnetic bearing of the expander/generator.

8. The engine system of claim 6, further comprising a housing enclosing both the expander/generator and the electronics package.

9. The engine system of claim 1, wherein the expander/generator comprises a generator having a permanent magnet rotor.

10. The engine system of claim 1, wherein the expander/generator comprises a generator having a magnetic bearing supporting a rotor of the expander/generator.

11. The engine system of claim 1, wherein the expander/generator comprises a turbine coupled to a rotor of a generator to rotate at the same speed as the rotor.

12. A method, comprising:
with a turbocharger coupled to an internal combustion engine, generating excess compressed air beyond operating requirements of the internal combustion engine; and
expanding the excess compressed air to generate electricity.

13. The method of claim 12, wherein expanding the excess compressed air to generate electricity comprises diverting a portion of the total compressed air generated by the turbocharger away from the engine to an expander/generator.

14. The method of claim 13, further comprising controlling an amount of compressed air diverted to the expander/generator based on the operating requirements of the internal combustion engine.

15. The method of claim 13, further comprising exhausting air from the expander/generator to an electronics package that receives electric power from the expander/generator and adjusts at least one of phase, frequency or voltage of the electric power.

16. The method of claim 13, further comprising directing air from a turbine of the expander/generator through a generator of the expander/generator.

17. A method performed on an internal combustion engine having a turbocharger coupled to the engine to receive exhaust from the engine, be driven to generate compressed air by the exhaust from the engine and to provide compressed air for combustion to the engine, the method comprising:
coupling an expander/generator between the turbocharger and the engine to receive at least a portion of the compressed air and generate electricity by expanding the received compressed air.

18. The method of claim 17, wherein coupling the expander/generator between the turbocharger and the engine comprises coupling the expander/generator to an intake conduit between the turbocharger and the engine and providing a valve between the expander/generator and the intake conduit.

19. The method of claim 17, further comprising coupling an outlet of the expander/generator to an electronics package to exhaust air from the expander/generator into the electronics package, the electronics package being of a type that is operable to adjust at least one of phase, frequency or voltage of electric power produced by the expander/generator.

20. The method of claim 19, wherein the expander/generator and the electronics package are in a common housing.
